(19) United States
(12) Patent Application Publication
(10) Pub. No.: US 2014/0305321 A1
(43) Pub. Date: Oct. 16, 2014

(54) MULTIFUNCTIONAL PROCESSOR

(71) Applicant: Jianzhang Zhou, Guangdong (CN)

(72) Inventor: Jianzhang Zhou, Guangdong (CN)

(21) Appl. No.: 14/347,868

(22) PCT Filed: Mar. 26, 2012
(86) PCT No.: PCT/CN2012/073069

§ 371 Date: May 16, 2014

(30) Foreign Application Priority Data
Sep. 27, 2011 (CN) 201120379290.7

(51) Int. Cl. A47J 27/05

(52) U.S. Cl. CPC A47J 27/05; A47J 2027/043
USPC 99/448

(57) ABSTRACT

A multifunctional processor comprises a base, a steam generator mounted on the base, and a cuisine cup assembly mounted on one side of the steam generator. The cuisine cup assembly comprises a cup body and a first steaming basket located in the cup body, and further comprises a second steaming basket ring forming an accommodation chamber with the first steaming basket during use of the cuisine cup assembly. The cuisine cup assembly of the multifunctional processor may use the second steaming basket ring according to actual needs. When the object to be heated is small, for example, in the case of only steaming, only the first steaming basket may be selected and used. When objects to be heated are various or large, for example, during steaming of more than two kinds of foods or milk-warming or food container sterilization, the first steaming basket, the second steaming basket ring, and a first steaming basket mesh are stacked together for use, or the first steaming basket and the second steaming basket ring are stacked together for use. A multifunctional baby food processor having multiple options is provided for a user.

### FIELD OF THE INVENTION

The present application relates to a processor, in particular to a multifunctional processor.

### BACKGROUND OF THE INVENTION

As for the existing processors, most only have a single function, e.g., a steaming function or a whisking function or a milk warming function or a sterilizing function, and most are bulky. Such kind of processors cannot satisfy users' requirement of multifunction. Thus, it is of great urgency to provide a multifunctional processor in a small volume.

### DISCLOSURE OF THE INVENTION

### Technical Problem

In view of the above, it is necessary to provide a multifunctional processor in a small volume.

### Technical Solution

The present application is realized in this way: a multifunctional processor comprising a base, a steam generator mounted on the base and a food processing cup assembly mounted on one side of the steam generator, the food processing cup assembly comprising a cup body and a first steam basket placed inside the cup body, and further comprising a second steam basket ring which may jointly form an accommodating cavity with the first steam basket when the food processing cup assembly is in use.

Further, the second steam basket ring is cylindrical, and a bottom of the second steam basket ring is detachably mounted on a top of the first steam basket.

Further, the second steam basket ring is cup-shaped, and the second steam basket ring is detachably mounted upside down on the first steam basket to form a larger cavity than the first steam basket.

Further, the food processing cup assembly further comprises a steam basket net, the steam basket net being detachably arranged between the first steam basket and the second steam basket ring, and dividing the accommodating cavity into two parts.

Further, the steam basket net is rotatably snap-fitted on the second steam basket ring.

Further, the food processing cup assembly further comprises a cup lid covered on the cup body and a lid body detachably mounted to the cup lid, the lid body being detachably snap-fitted on the cup lid inversely.

Further, the food processing cup assembly further comprises a third steam basket ring detachably superposed on the second steam basket ring and a lid body covered on the third steam basket ring when the food processing cup assembly is in use.

Further, the food processing cup assembly further comprises two steam basket nets, one of which is detachably arranged between the first steam basket and the second steam basket ring, and the other of which is detachably arranged between the second steam basket ring and the third steam basket ring.

Further, one of the two steam basket nets is rotatably snap-fitted on the second steam basket ring, and the other of the two steam basket nets is rotatably snap-fitted on the third steam basket ring.

Further, the food processing cup assembly further comprises a cup lid covered on the cup body, the lid body is detachably mounted on the cup lid, the lid body is snap-fitted inversely on the cup lid when the food processing cup assembly is not in use, and the lid body is removed from the cup lid and covered on the third steam basket ring when the food processing cup assembly is in use.

### Beneficial Effects

The food processing cup assembly of the multifunctional processor may use the second steam basket ring or the third steam basket ring according to actual requirements. When an object to be heated is small, e.g., when steaming only, one may select only using the first steam basket. When the objects to be heated are of various kinds or the object to be heated is in a larger size, e.g., when steaming more than two kinds of food or warming milk or sterilizing food containers, one may select superposing the first steam basket and the second steam basket ring and a steam basket net or the first steam basket and the second steam basket ring together for use, and may select superposing the first steam basket and the second steam basket ring and the third steam basket ring and two steam basket nets or the first steam basket and the second steam basket ring and the third steam basket ring together for use. In this way, a multifunctional processor is provided to users with multiple options.

Moreover, the abovementioned second steam basket ring and the third steam basket ring and two steam basket nets may all be stored simultaneously in the cavity formed between the first steam basket and the cup lid, thus saving the packaging space and user's storage space.

### BRIEF DESCRIPTION OF THE DRAWINGS

FIG. 1 is a plan view of a multifunctional processor of the application.

FIG. 2 is a sectional view of a food processing cup assembly in a state of storage according to a first embodiment of the multifunctional processor in FIG. 1.

FIG. 3 is a plan exploded view of the food processing cup assembly in a state of storage according to the first embodiment of the multifunctional processor in FIG. 1.

FIG. 4 is a stereo exploded view of the food processing cup assembly according to the first embodiment of the multifunctional processor in FIG. 1.

FIG. 5 is a stereo exploded view at another angle in FIG. 4.

FIG. 6 is an inverted view of a second steam basket ring in FIG. 4.

FIG. 7 is a sectional view of the food processing cup assembly in FIG. 4 in a state of usage.

FIG. 8 is a sectional view of the food processing cup assembly in FIG. 4 in another state of usage.

FIG. 9 is a sectional view of the food processing cup assembly in a state of storage according to a second embodiment of the multifunctional processor in FIG. 1.

FIG. 10 is a plan exploded view of the food processing cup assembly in a state of storage according to the second embodiment of the multifunctional processor in FIG. 1.

FIG. 11 is a stereo exploded view of the food processing cup assembly according to the second embodiment of the multifunctional processor in FIG. 1.

FIG. 12 is an inverted view of a second steam basket ring in FIG. 11.

FIG. 13 is a sectional view of the food processing cup assembly in FIG. 11 in a state of usage.

FIG. 14 is a sectional view of the food processing cup assembly in FIG. 11 in another state of usage.

### EMBODIMENT MODES OF THE INVENTION

To clarify the object, the technical solution and the advantages of the application, further detailed description is made hereunder to the application in combination with the drawings and the embodiments. It should be understood that the specific embodiments described herein are only for explaining the application, rather than limiting the application.

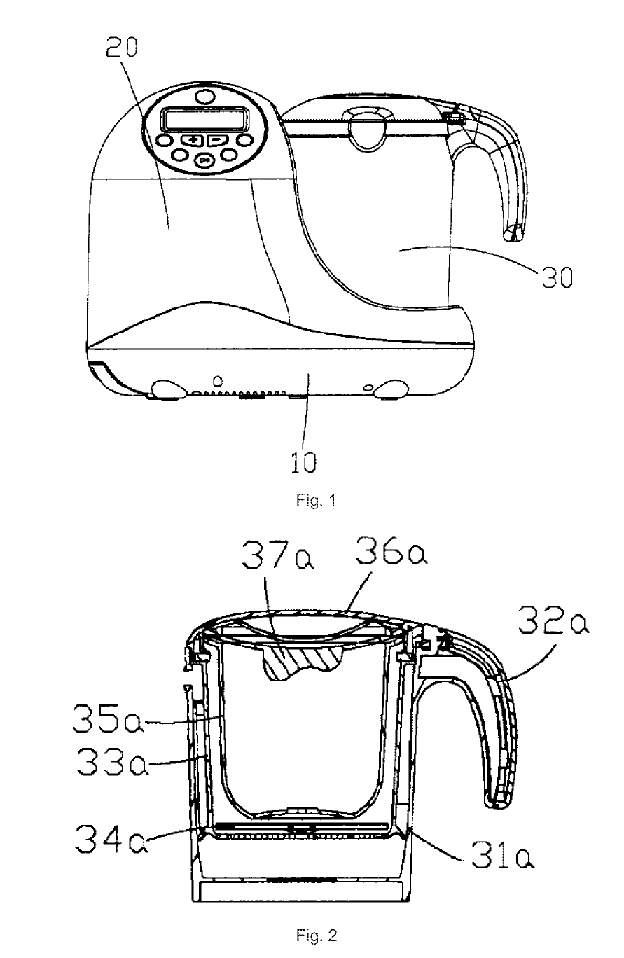

Please refer to FIG. 1. A multifunctional processor 100 in one embodiment of the application comprises a base 10, a steam generator 20 mounted on the base 10 and a food processing cup assembly 30 mounted on one side of the steam generator 20. The food processing cup assembly 30 of the multifunctional processor 100 has two embodiments.

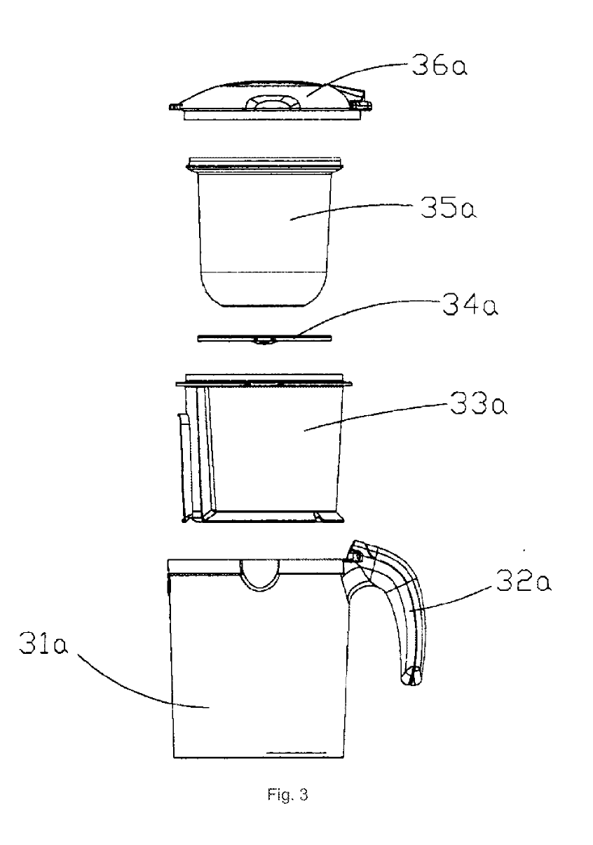

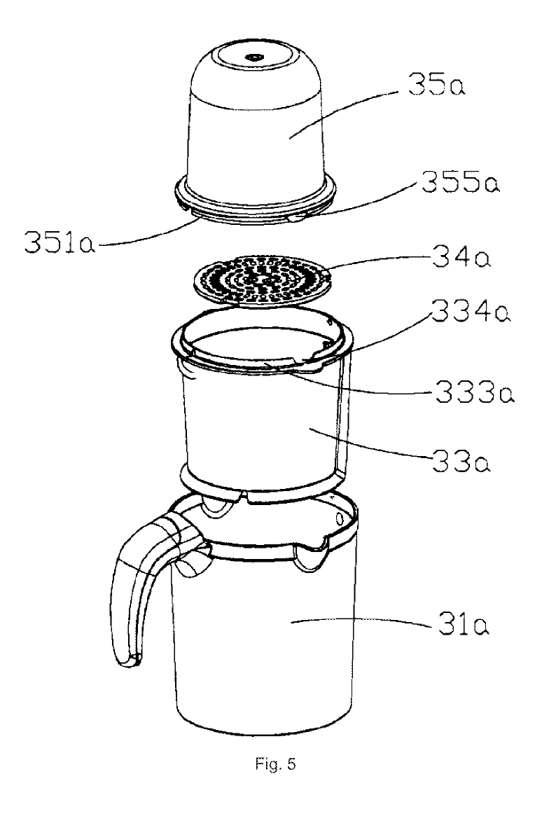

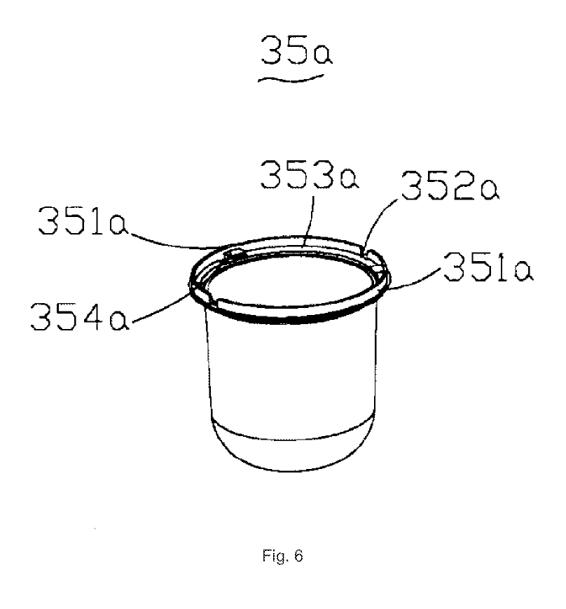

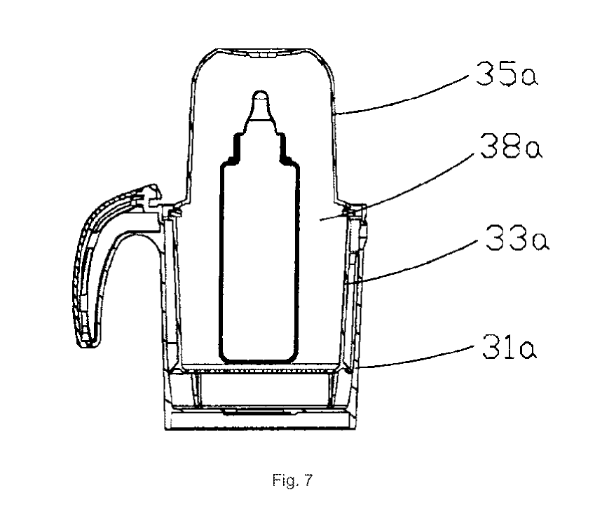

The food processing cup assembly 30a of the first embodiment is as illustrated in FIG. 2 to FIG. 8. Please refer to FIG. 2 and FIG. 3 first. The food processing cup assembly 30a comprises a cup body 31a, a cup handle 32a mounted on one side of the top of the cup body 31a, a first steam basket 33a placed inside the cup body 31a, a steam basket net 34a placed inside the first steam basket 33a, a second steam basket ring 35a placed inside the first steam basket 33a, a cup lid 36a covered on the top of the cup body 31a and a lid body 37a snap-fitted inversely on the cup lid 36a. When the food processing cup assembly 30a is not in use, the first steam basket 33a, the steam basket net 34a and the second steam basket ring 35a are all accommodated in the cup body 31a.

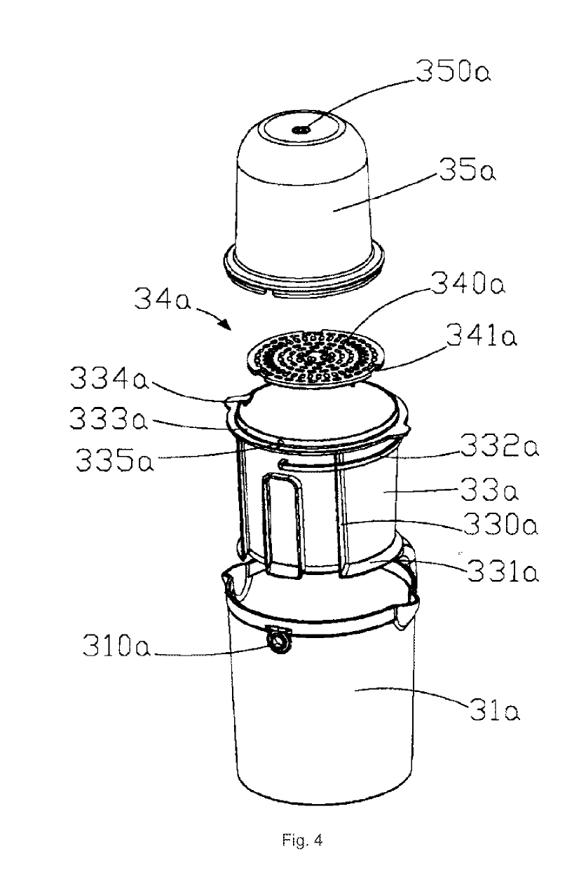

Please also refer to FIG. 4 to FIG. 8. When the food processor assembly 30a is in use, the first steam basket 33a is placed inside the cup body 31a, and the bottom of the second steam basket ring 35a is mounted on the top of the first steam basket 33a. The second steam basket ring 35a and the first steam basket 33a jointly form an accommodating cavity 38a. When there is a need to heat a larger object, the steam basket net 34a is not used, and the object to be heated, e.g., a nursing bottle, is placed inside the accommodating cavity 38a for heating. When the objects to be heated are small, the steam basket net 34a is mounted on the bottom of the second steam basket ring 35a, dividing the accommodating cavity 38a into two parts. The objects can be heated inside both of the two parts of the cavity.

A steam inlet 310a is arranged at the rim of the cup body 31a to provide an inlet for the steam generated by the steam generator 20. The periphery of the first steam basket 33a extends outward to form two first barrier strips 330a which vertically extend downward. The periphery of the bottom of the first steam basket 33a extends outward and obliquely to form a second barrier strip 331a. The first barrier strips 330a and the second barrier strip 331a jointly form a steam passage (not shown). The steam passage is in communication with the steam inlet 310a. Steam enters the steam passage via the steam inlet 310a, and flows into the bottom of the first steam basket 33a, and then enters the first steam basket 33a via steam through-holes (not shown) on the bottom of the first steam basket 33a. One carrying handle 332a is mounted on the top of the first steam basket 33a. The top of the first steam basket 33a extends upward to form a first mounting part 333a. The first mounting part 333a is an annular structure, on which one first indentation 334a and two mounting holes 335a are provided. The mounting holes 335a are used to mount two opposite ends of the carrying handle 332a.

There are several air-holes 340a provided on the steam basket net 34a. Several second indentations 341a are provided on the periphery of the steam basket net 34a. A rotary handle (not shown) is arranged in the middle of the steam basket net 34a to facilitate rotation of the steam basket net 34a. The steam basket net 34a is rotatably snap-fitted on the second steam basket ring 35a.

The second steam basket ring 35a is cup-shaped. A steam outlet 350a is provided on the bottom of the second steam basket ring 35a. The top of the second steam basket ring 35a extends upward to formone second mounting part 351a. The second mounting part 351a is an annular structure, on which two third indentations 352a are provided for accommodating two ends of the carrying handle 332a. A step 353a is formed between the inner circumference surfaces of the second mounting part 351a and the second steam basket ring 35a. The inner circumference surface of the second mounting part 351a extends inward to form several clamping parts 354a. The number of the clamping parts 354a is the same as the number of the second indentations 341a of the steam basket net 34a. When the clamping parts 354a pass through the second indentations 341a of the steam basket net 34a, the rotary handle of the steam basket net 34a is rotated so that the steam basket net 34a rotates relatively relative to the second steam basket ring 35a. At this moment, the clamping parts 354a are positioned above the edge of the steam basket net 34a, and clamp the steam basket net 34a, so as to clamp the steam basket net 34a on the second steam basket ring 35a. When the steam basket net 34a is rotated towards an opposite direction, and the second indentations 341a correspond to the clamping parts 354a, the steam basket net 34a can be removed. The exterior of the second mounting part 351a extends to form a lug 355a. When the second steam basket ring 35a is mounted to the first steam basket 33a, the outer side of the second mounting part 351a adheres to the inner side of the first mounting part 333a, and the lug 355a is snap-fitted inside the first indentation 334a of the first mounting part 333a to limit rotation of the second steam basket ring 35a relative to the first steam basket 33a.

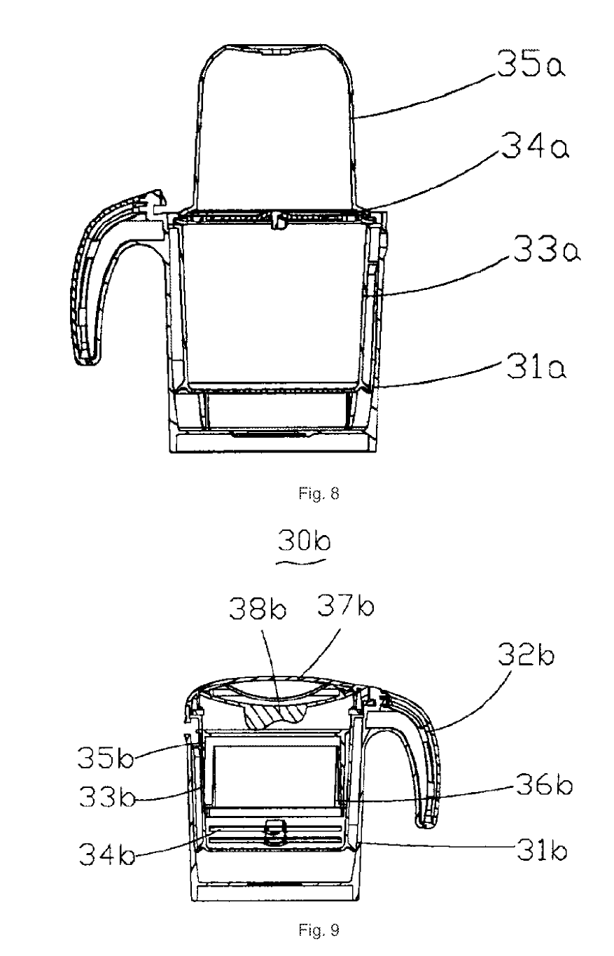

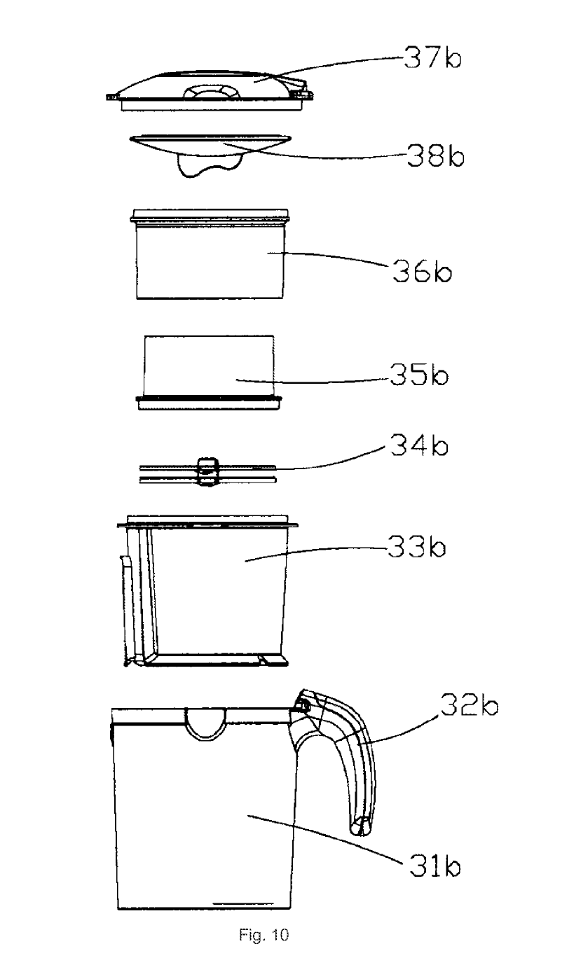

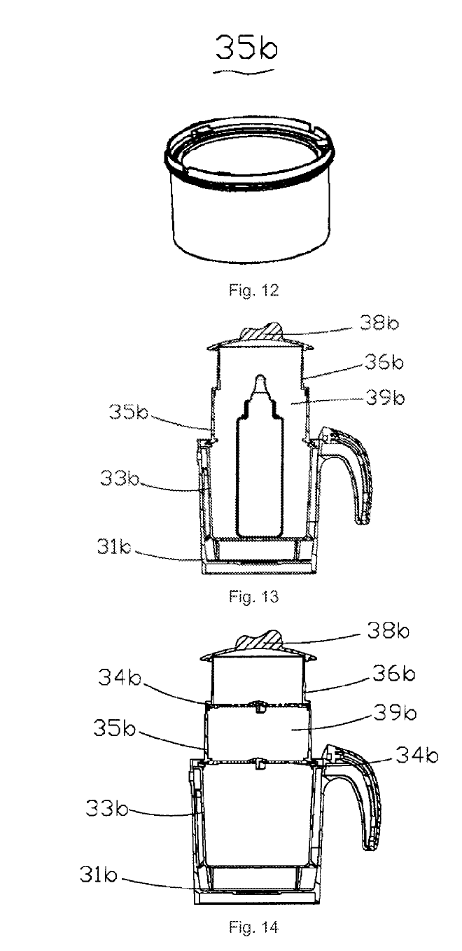

The food processing cup assembly 30b of the second embodiment is as illustrated in FIG. 9 to FIG. 14. Please refer to FIG. 9 and FIG. 10 first. The food processing cup assembly 30b comprises a cup body 31b, a cup handle 32b mounted on one side of the top of the cup body 31b a first steam basket 33b placed inside the cup body 31b, two steam basket nets 34b placed inside the first steam basket 33b, a second steam basket ring 35b placed inside the first steam basket 33b, a third steam basket ring 36b placed inside the second steam basket ring 35b, a cup lid 37b covered on the top of the cup body 31b and a lid body 38b snap-fitted inversely on the cup lid 37b. When the food processing cup assembly 30b is not in use, the first steam basket 33b, the steam basket nets 34b, the second steam basket ring 35b and the third steam basket ring 36b are all accommodated in the cup body 31b.

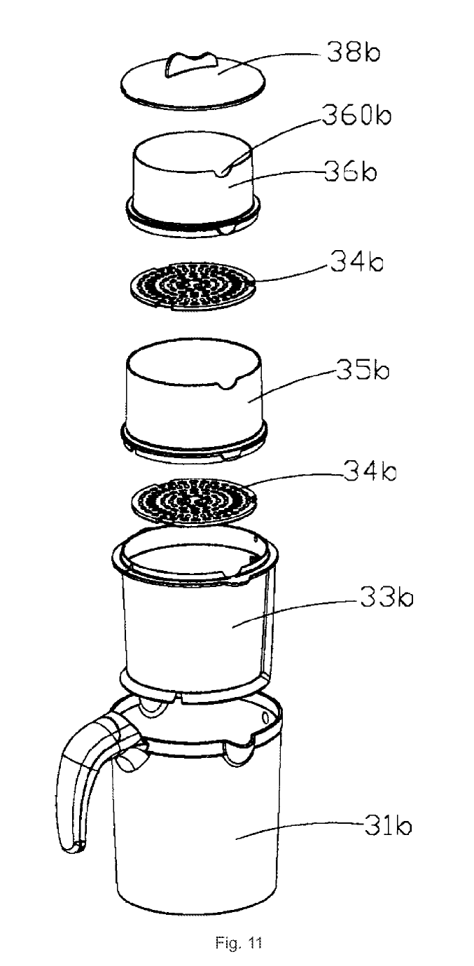

Please also refer to FIG. 11 to FIG. 14. When the food processor assembly 30b is in use, the first steam basket 33b is placed inside the cup body 31b, and the bottom of the second steam basket ring 35b is mounted on the top of the first steam basket 33b. The bottom of the third steam basket ring 36b is mounted on the top of the second steam basket ring 35b. The lid body 38b is detached from the cup lid 37b, and covered on the top of the third steam basket ring 36b. The first steam basket 33b, the second steam basket ring 35b, the third steam basket ring 36b and the lid body 38b jointly form an accommodating cavity 39b. When there is a need to heat a larger object, the steam basket nets 34b are not used, and the object to be heated, e.g., a nursing bottle, is placed inside the accommodating cavity 39b for heating. When the objects to be heated are small, the steam basket nets 34a are respectively mounted on the bottom of the second steam basket ring 35b and the bottom of the third steam basket ring 36b, dividing the accommodating cavity 39b into three parts. The objects can be heated inside all of the three parts of the cavity. The second steam basket ring 35b and the third steam basket ring 36b are each in a structure of a cylinder head.

The structure of the cup body 31b is identical to the structure of the cup body 31a; the structure of the steam basket nets 34b is identical to the structure of the steam basket net 34a; the steam basket nets 34b are rotatably snap-fitted on the second steam basket ring 35b and the third steam basket ring 36b. The steam basket net 34b is snap-fitted to the second steam basket ring 35b in the same manner as the steam basket net 34b being snap-fitted to the third steam basket ring 36b, and as the steam basket net 34a being snap-fitted to the second steam basket ring 35a. The first steam basket 33b is snap-fitted to the second steam basket ring 35b in the same manner as the second steam basket ring 35b being snap-fitted to the third steam basket ring 36b, and as the first steam basket 33a being snap-fitted to the second steam basket ring 35a. A indentation 360 is provided on the top of the third steam basket ring 36b. The lid body 38b is covered on the top of the third steam basket ring 36b, and the indentation 360 forms a steam outlet.

The multifunctional processor 100 of the application has food processing cup assembly 30a, 30b, and at least the first steam basket 33a, 33b and the second steam basket ring 35a, 35b may be superposed together to form a larger cavity, so that a larger object, e.g., a nursing bottle, can be heated. Each of the parts of the food processing cup assembly 30a, 30b can be disassembled freely. Users can flexibly accomplish heating different objects in a more convenient manner according to actual requirements.

The food processing cup assembly of the multifunctional processor may use the second steam basket ring 35a, 35b according to actual requirements. When an object to be heated is small, e.g., when steaming only, one may select only using the first steam basket 33a, 33b. When the object to be heated is larger, e.g., when warming milk or sterilizing food containers, one may select superposing the first steam basket 33a, 33b and the second steam basket ring 35a, 35b together for use. In this way, a multifunctional processor is provided to users with multiple options.

The above are only preferred embodiments of the application, and are not used to limit the application. Any amendments, equivalent replacements, improvements and the like made within the spirit and scope of the application shall all be included in the protection scope of the application.

1. A multifunctional processor comprising:
a base;
a steam generator mounted on the base;
a food processing cup assembly mounted on one side of the steam generator; and
wherein the food processing cup assembly comprises a cup body and a first steam basket placed inside the cup body, and further comprises a second steam basket ring which may jointly form an accommodating cavity with the first steam basket when the food processing cup assembly is in use.

2. The multifunctional processor according to claim 1, wherein the second steam basket ring is cylindrical, and a bottom of the second steam basket ring is detachably mounted on a top of the first steam basket.

3. The multifunctional processor according to claim 1, wherein the second steam basket ring is cup-shaped, and the second steam basket ring is detachably mounted upside down on the first steam basket.

4. The multifunctional processor according to claim 1, wherein the food processing cup assembly further comprises a steam basket net, the steam basket net being detachably arranged between the first steam basket and the second steam basket ring, and dividing the accommodating cavity into two parts.

5. The multifunctional processor according to claim 4, wherein the steam basket net is rotatably snap-fitted on the second steam basket ring.

6. The multifunctional processor according to claim 4, wherein the food processing cup assembly further comprises a cup lid covered on the cup body and a lid body detachably mounted to the cup lid, the lid body being detachably snap-fitted on the cup lid inversely.

7. The multifunctional processor according to claim 1, wherein the food processing cup assembly further comprises a third steam basket ring detachably superposed on the second steam basket ring and a lid body covered on the third steam basket ring when the food processing cup assembly is in use.

8. The multifunctional processor according to claim 7, wherein the food processing cup assembly further comprises two steam basket nets, one of which is detachably arranged between the first steam basket and the second steam basket ring, and the other of which is detachably arranged between the second steam basket ring and the third steam basket ring.

9. The multifunctional processor according to claim 8, wherein one of the two steam basket nets is rotatably snap-fitted on the second steam basket ring, and the other of the two steam basket nets is rotatably snap-fitted on the third steam basket ring.

10. The multifunctional processor according to claim 7, wherein the food processing cup assembly further comprises a cup lid covered on the cup body, the lid body is detachably mounted on the cup lid, the lid body is snap-fitted on the cup lid inversely when the food processing cup assembly is not in use, and the lid body is removed from the cup lid and covered on the third steam basket ring or the second steam basket ring when the food processing cup assembly is in use.
